(19) United States
(12) Patent Application Publication
(10) Pub. No.: US 2020/0166020 A1
(43) Pub. Date: May 28, 2020

(54) WIND TURBINE HUB

(71) Applicant: Siemens Gamesa Renewable Energy Innovation & Technology S.L., Sarriguren (Navarra) (ES)

(72) Inventor: Carlos Bienes Archel, Huarte (ES)

(21) Appl. No.: 16/683,415

(22) Filed: Nov. 14, 2019

(30) Foreign Application Priority Data
Nov. 28, 2018 (EP) 18380018.4

(51) Int. Cl. F03D 80/50; F03D 1/06

(52) U.S. Cl. CPC F03D 80/50; F03D 1/0691

(57) ABSTRACT

Provide is a wind turbine hub including at least a main body portion realized for connection to a plurality of rotor blades, and including an interior cavity dimensioned to accommodate service personnel; a removable access hatch arranged at the front of the hub; a locking arrangement realized to lock the access hatch in place and to release the access hatch from its locked state to expose an access opening at the front of the hub; and wherein the access hatch and locking arrangement are constructed to allow the released access hatch to be moved only into the interior cavity of the main body portion. Also provided is a method of operating an access hatch of such a wind turbine hub and a wind turbine.

### CROSS-REFERENCE TO RELATED APPLICATIONS

This application claims priority to European Application No. 18380018.4, having a filing date of Nov. 28, 2018, the entire contents of which are hereby incorporated by reference.

### FIELD OF TECHNOLOGY

The following describes a wind turbine hub, a method of operating an access hatch of a wind turbine hub, and a wind turbine.

### BACKGROUND

It is usually necessary to perform maintenance or repair work to components of a wind turbine. Even with appropriate safety measures in place, such service procedures can be hazardous, and it may be that a person sustains injury. When the injured person is located in the interior cavity of the wind turbine hub, rescue can be time-consuming and difficult. In prior art wind turbine designs, the injured person may need to be transferred to the nacelle. From there, the injured person can be transferred to a heli-hoist platform or can be lowered through the tower interior. These maneuvers can add to the severity of the injury, particularly in the case of head or spinal injuries which are time-critical and generally require that the injured person is moved as little as possible. In some designs, the hub includes a hatch to the outside. However, if the hatch is not already in a suitable position through which the injured person can be moved, it may not be possible to turn the rotor without risking further injury to the patient.

### SUMMARY

An aspect relates to an improved way of transferring an injured person from a wind turbine hub.

According to embodiments of the invention, the wind turbine hub comprises a main body portion realized for connection to a plurality of rotor blades and comprising an interior cavity dimensioned to accommodate service personnel; a removable access hatch arranged at the front of the hub, i.e. upwind of the main body portion; and a locking arrangement realized to lock the access hatch in place on the hub and to release the access hatch from its locked state to expose an access opening at the front of the hub; and wherein the access hatch and locking arrangement are constructed to allow the released access hatch to be moved into the interior cavity of the main body portion. This last feature shall be understood to mean that the access hatch can only be moved in one principle direction, namely into the hub interior, and that it cannot be moved to the hub exterior.

An advantage of the inventive wind turbine hub is that the locking arrangement can quickly and safely provide an access opening to the exterior. By providing an access opening directly from the hub, the time taken to transfer an injured person out of the hub can be significantly reduced. In addition, because the access hatch can simply be detached from the hub to reveal the access opening, there is no need to turn the aerodynamic rotor into a specific position, as would be the case with a prior art hinged access hatch. Furthermore, since the access hatch is detached and then moved into the interior cavity of the hub, there is no danger of the access hatch falling outside the hub.

According to embodiments of the invention, the method of operating an access hatch of such a wind turbine hub comprises the steps of actuating the locking arrangement to release the access hatch from its locked state to expose an access opening at the front of the hub, and subsequently moving the released access hatch into the interior cavity of the main body portion; or positioning the access hatch to close the access opening at the front of the hub and subsequently actuating the locking arrangement to lock the access hatch in place on the hub.

An advantage of the inventive method is that the time taken to transfer an injured person out of the hub interior can be significantly reduced. It is no longer necessary to transfer the injured person into the nacelle, so valuable time can be saved. Not having to transfer the injured person from the hub to the nacelle also means that the person need not be moved about unnecessarily. It is particularly important to reduce the rescue time in case of head or spinal injuries. Equally, for this type of injury, it is important not to move the patient unnecessarily.

According to embodiments of the invention, the wind turbine comprises—amongst other relevant components—an aerodynamic rotor, which aerodynamic rotor comprises a number of rotor blades mounted to an embodiment of the inventive wind turbine hub.

In the following, it may be assumed that the wind turbine hub is part of an aerodynamic rotor comprising three rotor blades mounted to the hub, for example by means of pitch bearings. To this end, the hub may be assumed to comprise an inner framework to provide the necessary structural stability, particularly in the case of very long rotor blades, and an outer housing with a smooth outer surface. The housing is generally referred to as the “spinner”. The housing may be assumed to terminate as a rounded cone or nose at the front of the hub. The access hatch is arranged at the front of the hub and therefore comprises at least a portion of the spinner “nose”. In the following, without restricting embodiments of the invention in any way, it may be assumed that the access hatch has a rounded conical shape, i.e. the access hatch is bowl-shaped or calotte-shaped.

The nose of the hub may be described as being “upwind” of the rest of the hub, since the hub of a wind turbine is generally pointed to face into the wind. Similarly, anything located behind the nose may be described as being “downwind” of the nose.

Since the purpose of the locking arrangement is to lock the access hatch in place but also to allow the access hatch to be removed, the locking arrangement may equally well be referred to as a release mechanism, a locking mechanism, a lock/release mechanism, etc. in the following.

The removable access hatch may be realized as the foremost portion of the wind turbine hub, i.e. the most upwind portion of the wind turbine hub with respect to a rotational axis of the hub and assuming the hub is facing into the wind.

The diameter of the access opening may be at least 50 cm, or in other embodiments at least 60 cm. An access opening with such a minimum diameter should be sufficient to allow an injured person to be transferred out of the hub. Of course, a larger diameter is possible, for example a diameter of about 1.0 m.

In an exemplary embodiment of the invention, the locking arrangement comprises a first annular structure arranged about the access hatch, and a second, complementary inward-facing annular structure arranged on the main body portion. These annular structures may be regarded as collars or flanges and may be realized to match each other in width and size. The annular structures may be made of any suitable material such as injection-molded plastic and may be flexible to some extent.

Being in the form of a collar or flange, such an annular structure comprises an outer diameter and a smaller inner diameter. The outer diameter of the first annular structure may exceed the diameter of the access opening. In this way, the access hatch cannot fall out after being released from the main body portion of the hub. The first annular structure may be referred to as the inner collar in the following, and the second annular structure may be referred to as the outer collar.

In an exemplary embodiment of the invention, the locking arrangement is accessible from the interior cavity. This means that the locking arrangement can be operated by a person inside the hub. In a further exemplary embodiment of the invention, the access hatch is equipped with one or more handles so that the operator can easily grasp these to draw the access hatch backwards into the hub interior, where it can be safely stowed, for example during a rescue operation.

There are various ways of obtaining a suitable locking arrangement that can be opened from within, such as by a single person and requiring at most a simple tool, and which will allow the access hatch to be detached and moved into the hub interior. Another design consideration is that a watertight seal should be provided about the access opening.

In an exemplary embodiment of the invention, the locking arrangement comprises a number of two-part locking devices, wherein the first part of a locking device is permanently mounted to the inner collar, for example by riveting. Similarly, the second part of the locking device is permanently mounted to the outer collar. In such an embodiment, a two-part locking device comprises a release mechanism that can be opened to release the first part from the second part, so that the inner collar can be detached from the outer collar (allowing the access hatch to be drawn into the hub interior). Similarly, the release mechanism can be closed to lock the first part to the second part (effectively securing the access hatch in place at the front of the hub).

There are various ways of designing a release mechanism for connecting the inner and outer collars. A release mechanism can be constructed in any suitable manner, for example to function as a latch. In an exemplary embodiment of the invention, the release mechanism comprises a moveable hook arranged in the first part to engage a pin positioned in the second part. The release mechanism is easily actuated, for example by a simple hand-held Allen key. In such an embodiment, the hook may be provided with a hex socket, and the hook can be moved by an Allen key inserted into the hex socket.

Because of the ease with which each lock feature pair can be opened, the access hatch can be released very quickly. The access hatch can then be lifted into the hub interior, where it can rest against a side wall or be suspended from a suitable hook arrangement, for example.

The locking arrangement may comprise at least three such release mechanisms. In some embodiments, at least six such release mechanisms may be arranged equidistantly about the access hatch.

In an alternative embodiment of the invention, a release mechanism can comprise a recessed portion formed in the outer collar, and a complementary projecting portion formed in the inner collar and shaped to fit inside the recessed portion. The recessed portion may be regarded as a “shoe”, while the complementary projecting portion may be regarded as a “foot”. These features may be secured to each other in such a way that the inner collar will not detach from the outer collar, i.e. the access hatch will not detach, unless a person deliberately opens the release mechanism. In such an embodiment, the means of engaging the first and second lock features may comprise a rotatable bar shaped to lock the projecting portion in the recessed portion. A person inside the hub can turn each rotatable bar by the required amount (e.g. a quarter turn) to open (or close) the release mechanisms. In this embodiment, actuating the locking arrangement can be performed manually by a single person without the need for any tools.

The wind turbine spinner can be designed so that it comprises a main body portion and the access hatch. In such an embodiment, the second annular structure or outer collar is formed about a circular opening at the front of the main body portion. Alternatively, a wind turbine spinner can be designed to comprise a main body portion and a two-part nose or front portion. In such an embodiment, the two-part nose comprises the circular access hatch and an annular adapter realized for mounting between the access hatch and the main body portion. In this case, the second annular structure or collar is formed about a circular opening at the front or upwind end of the annular adapter. The downwind end is designed to attach to a corresponding opening at the front of the main body portion. The advantage of this design is that a single access hatch design can be used with different spinner designs, simply by providing appropriate annular adapters. Equally, a simple nose without any other function can be replaced by a nose that also serves as an access hatch.

In an exemplary embodiment of the invention, the wind turbine hub is designed and constructed to accommodate a rescue arrangement, which rescue arrangement can be temporarily or permanently installed in the interior cavity of the hub, and comprises a means of moving a horizontal stretcher through the access opening; a hoist rope adapted for connection to the stretcher; and a winch configured to lower the stretcher to a level below the hub, e.g. towards ground level or to the deck of a waiting marine vessel. Equally, a rescue arrangement may be realized to transfer a stretcher outwards from the access opening, for example using a pair of rails or similar, so that a helicopter can connect to the stretcher.

### BRIEF DESCRIPTION

Some of the embodiments will be described in detail, with reference to the following figures, wherein like designations denote like members, wherein:

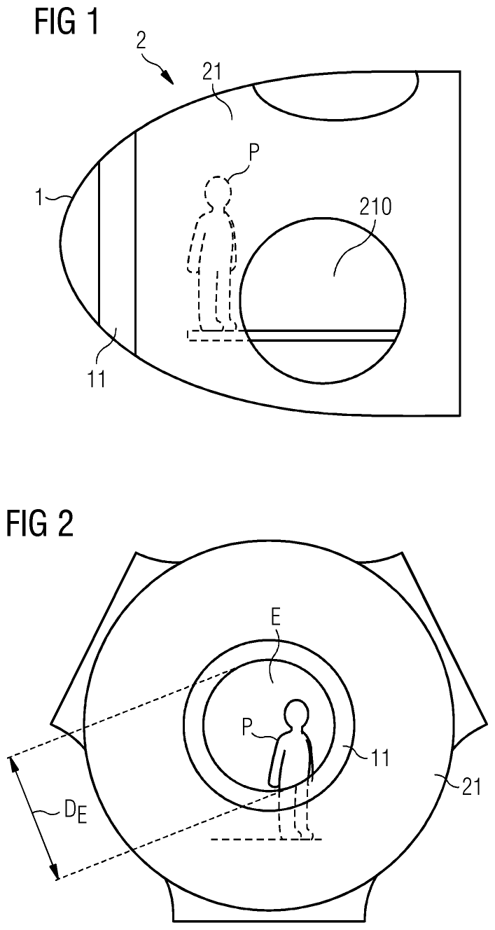

FIG. 1 shows a cross-section through an embodiment of the inventive wind turbine hub;

FIG. 2 shows a front view of the wind turbine hub of FIG. 1;

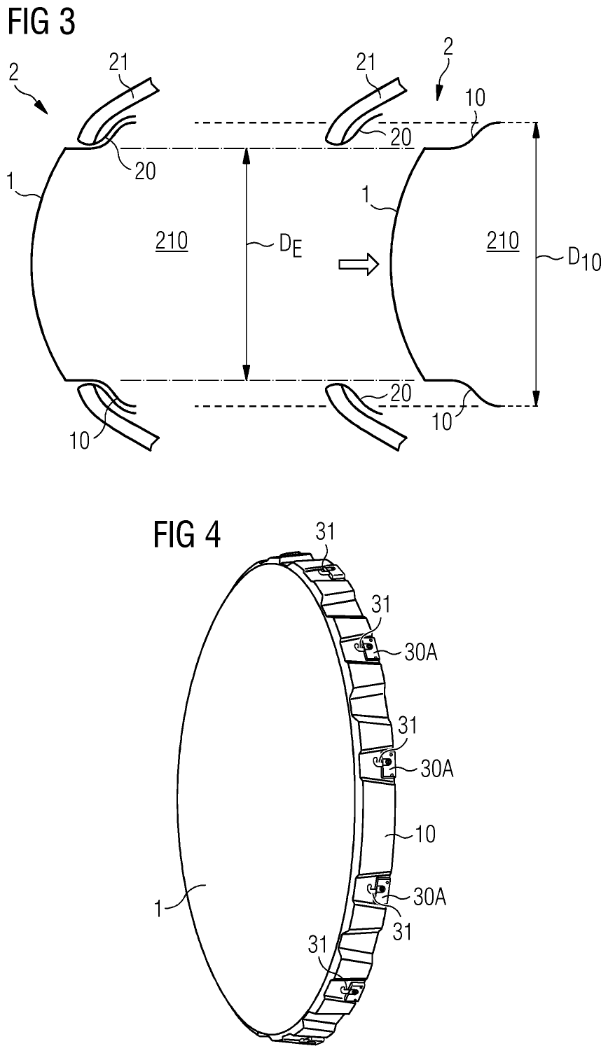

FIG. 3 shows a simplified cross-section through the upwind portion of a further embodiment of the inventive wind turbine hub;

FIG. 4 shows an embodiment of an inner collar about an access hatch in an embodiment of the inventive wind turbine hub;

FIG. 5 shows a cutaway view through mated inner and outer collars in an embodiment of the inventive wind turbine hub;

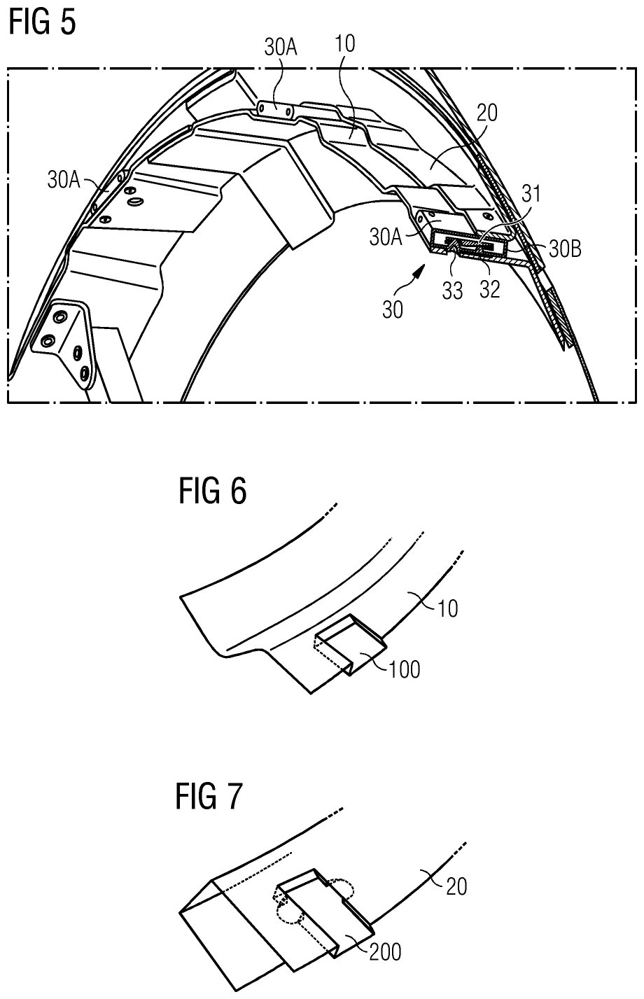

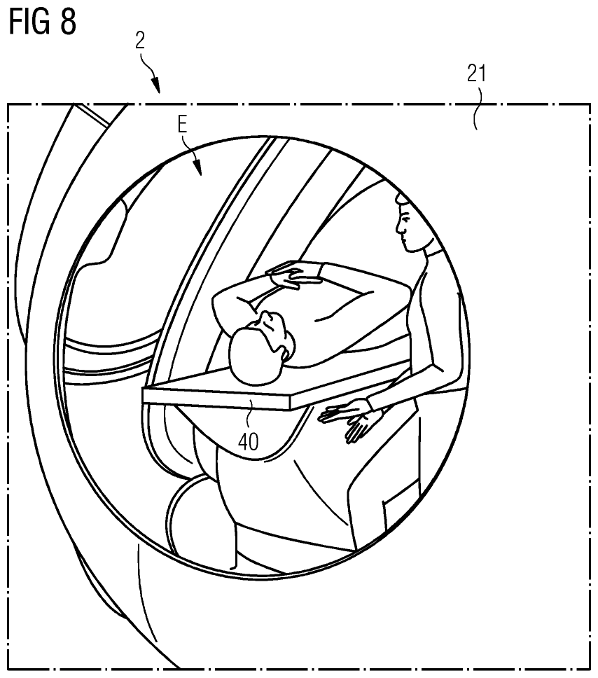

FIGS. 6 and 7 show an alternative realization of a locking arrangement;

FIG. 8 shows a stage during a rescue procedure carried out in an embodiment of the inventive wind turbine hub; and

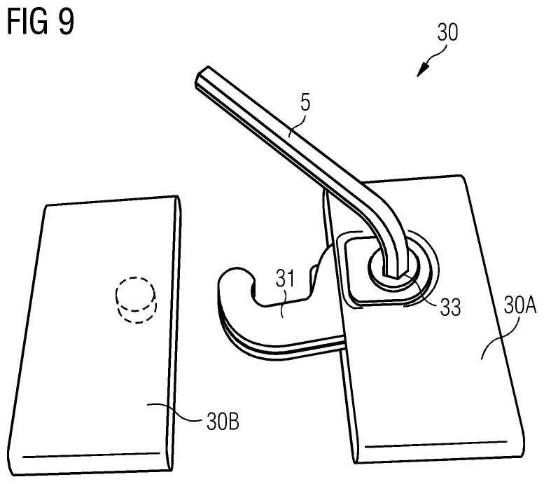

FIG. 9 shows a release mechanism as used in FIGS. 4 and 5.

### DETAILED DESCRIPTION

FIG. 1 shows an embodiment of the inventive wind turbine hub 2. Maintenance work can be carried out by service personnel P in the interior cavity 210 of the hub 2. The hub 2 comprises a main portion 21 and a two-part nose or front portion 1, 11. The two-part front portion 1, 11 comprises an annular ring 11 that is fixed relative to the main portion 21, and a removable access hatch 1. FIG. 2 shows a front view of the same wind turbine hub 2 after release of the removable access hatch 1, giving a view through an access opening E (with diameter D_{E}) into the interior 210 of the hub 2. The removable access hatch 1 may be assumed to be stowed in the interior 210 of the hub 2.

FIG. 3 shows a simplified cross-section through the upwind portion of an alternative embodiment of the inventive wind turbine hub 2, showing the wind turbine hub 2 in its “closed” state (on the left-hand side) and in its “open” state (on the right-hand side). On the left-hand side, the diagram shows an upwind removable access hatch 1 connected to the downwind hub portion 21 by means of complementary annular structures 10, 20 in the form of flanges or collars, and a lock/release mechanism (not shown). The diagram serves to illustrate the inward displacement of the removable access hatch 1 into the interior cavity 210 of the hub 2 in the direction indicated by the arrow. This is facilitated by the orientation of the annular collars 10, 20. By releasing the removable access hatch 1 and pulling it into the interior cavity 210, an access opening E with a diameter D_{E} is revealed. An injured person can be placed on a stretcher and comfortably transferred through the exit opening from the hub to the outside.

FIG. 4 shows an embodiment of the inner collar 10, i.e. the collar or flange formed about the access hatch 1. The diagram indicates a possible complex shape of the inner collar 10, with raised and recessed portions that will provide a form-fit with a complementary inward-facing collar 20 (shown in FIG. 3) formed about the access opening at the front of the hub. This diagram also shows a number of release mechanism parts 30 attached to the inner collar 10. Each release mechanism first part 30 has a latch hook 31 that will engage a pin of a release mechanism second part 30B. This is illustrated in FIG. 5, which shows a cutaway view through the mated or locked inner and outer collars 10, 20. The diagram shows a number of two-part release mechanisms 30, one in cutaway view, showing a latch hook 31 of a first part 30A engaged with a pin 32 of a second part 30B. The diagram also indicates a hex socket 33. An Allen key can be inserted into the hex socket 33 and turned to either open the release mechanism or to close it.

Several such release mechanisms 30 are provided about the circumference of the access opening. While three can be sufficient to hold the removable access hatch 1 in place, it may be preferred to provide more, for example six, nine, or twelve such release mechanisms.

FIGS. 6 and 7 show an alternative realization of a locking arrangement. Here, FIG. 6 shows a section of the first annular collar 10 arranged about the removable access hatch 1. The diagram also shows a projecting structure 100 of the lock/release mechanism, shaped as a flat “foot”. The projecting structure 100 has sloped side faces. FIG. 7 shows a section of the second annular collar 20 arranged to face inwards to the interior cavity of the hub. This annular collar 20 can be part of the main body portion of the hub for attaching to the access hatch or can be part of a two-part nose which is mounted to the main body portion of the hub. The diagram also shows a recess 200 of the lock/release mechanism, shaped with slanted side faces to accommodate the projecting structure 100 of the first annular collar 10 of FIG. 6. This second collar 20 is shaped to lie against the first collar 10 when the footrests inside the shoe. The “foot” may be regarded as a male part of a form-fit connection, while the “shoe” may be regarded as a female part.

FIG. 8 shows a stage during a rescue procedure. An injured person has been placed on a stretcher 4 which can be moved through the access opening E. A hoist rope (not shown) may be assumed to be connected to the stretcher 4, and a winch (not shown) is provided in the hub interior to lower the stretcher 40 to a level below the hub 2.

FIG. 9 shows a release mechanism 30 as used in the embodiment described in FIGS. 4 and 5. The diagram shows the two-part release mechanism 30 comprising a first part 30A and a second part 30B. Each of these can be bolted riveted or otherwise fastened to the inner collar 10 and outer collar 20 respectively. The diagram also shows a moveable hook 31 which is shaped to engage with a pin positioned inside the second part 30B. To move the hook 31, a hex socket 33 is provided. An Allen key 5 is used to rotate the hex socket in one direction to release the hook 31 from the pin, or to rotate the hex socket in the opposite direction to engage the hook 31 with the pin.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A wind turbine hub comprising at least
a main body portion realized for connection to a plurality of rotor blades, and comprising an interior cavity dimensioned to accommodate service personnel;
a removable access hatch arranged at the front of the hub;
a locking arrangement realized to lock the access hatch in place and to release the access hatch from its locked state to expose an access opening at the front of the hub; and wherein the access hatch and locking arrangement are constructed to allow the released access hatch to be moved only into the interior cavity of the main body portion.

2. The wind turbine hub according to claim 1, wherein the removable access hatch is realized as the foremost portion of the wind turbine hub.

3. The wind turbine hub according to claim 1, wherein the locking arrangement is accessible from the interior cavity.

4. The wind turbine hub according to claim 1, wherein the locking arrangement comprises a first annular structure arranged about the access hatch and a complementary second annular structure arranged on the main body portion.

5. The wind turbine hub according to claim 4, wherein each annular structure comprises an outer diameter and a smaller inner diameter, and wherein the outer diameter of the first annular structure exceeds the diameter of the access opening.

6. The wind turbine hub according to claim 4, wherein the locking arrangement comprises a number of two-part locking devices, wherein the first part of a locking device is mounted to the first annular structure and wherein the second part of the locking device is mounted to the second annular structure, and wherein a two-part locking device comprises a release mechanism that can be opened to release the first part from the second part or closed to lock the first part to the second part.

7. The wind turbine hub according to claim 6, wherein the release mechanism comprises a hook arranged in the first part to engage a pin arranged in the second part.

8. The wind turbine hub according to claim 6, wherein the release mechanism is constructed to be actuated by an Allen key.

9. The wind turbine hub according to claim 6, wherein the locking arrangement comprises at least three locking devices arranged equidistantly about the access hatch.

10. The wind turbine hub according to claim 1, wherein the diameter of the access opening is at least 0.5 m.

11. The wind turbine hub according to claim 1, further comprising an annular adapter realized for mounting between the access hatch and the main body portion, which annular adapter comprises elements of the locking arrangement.

12. The wind turbine hub according to claim 1, adapted to accommodate a rescue assembly, which rescue assembly comprises
a means of securing a stretcher being moved through the access opening;
a hoist rope for connection to the stretcher; and
a winch configured to lower the stretcher to a level below the hub.

13. A method of operating an access hatch of a wind turbine hub according to claim 1, comprising the steps of
opening the locking arrangement to release the access hatch from its locked state to expose an access opening at the front of the hub, and subsequently moving the released access hatch into the interior cavity of the main body portion; or
positioning the access hatch to close the access opening at the front of the hub and subsequently closing the locking arrangement to lock the access hatch in place on the hub.

14. The method according to claim 13, wherein the step of opening and closing the locking arrangement are performed with a hand-held Allen key.

15. A wind turbine comprising an aerodynamic rotor, which aerodynamic rotor comprises a number of rotor blades mounted to a hub according to claim 1.

16. The wind turbine hub according to claim 6, wherein the locking arrangement comprises at least six locking devices arranged equidistantly about the access hatch.

17. The wind turbine hub according to claim 1, wherein the diameter of the access opening is at least 0.6 m.
